(19) United States
(12) Patent Application Publication
(10) Pub. No.: US 2015/0156173 A1
(43) Pub. Date: Jun. 4, 2015

(54) Communication system utilizing fingerprint information and use thereof

(71) Applicant: WWTT TECHNOLOGY CHINA, Jiangmen, Guangdong (CN)

(72) Inventors: Kwok fong Wong, Heshan (CN); Pui yi Ching, Heshan (CN)

(21) Appl. No.: 13/881,365

(22) PCT Filed: Nov. 10, 2012
(86) PCT No.: PCT/CN2012/084424

§ 371 Date: Apr. 24, 2013

(30) Foreign Application Priority Data
Aug. 21, 2012 (CN) 201210297595.2

(51) Int. Cl. H04L 29/06; H04L 12/58; H04L 9/32

(52) U.S. Cl. CPC H04L 63/0428; H04L 9/3231; H04L 63/0861; H04L 51/32

(57) ABSTRACT

The invention discloses a communication system utilizing fingerprint information, which comprises a fingerprint sensor and a communication application unit, the communication application unit includes a communication software, an encrypting software and a decrypting software reverse to the encrypting software. The communication system comprises a step (A) of adding friends, a step (B) of encrypting and sending a message, and a step (C) of decrypting and recognizing a message. According such system of the invention, encryption and decryption management can be performed by utilizing fingerprint information, thereby, anyone who doesn't have matching fingerprint information can not read the encrypted message(s), and thus the privacy and safety of user information can be improved greatly on the basis of original systems.

### FIELD OF THE INVENTION

The invention relates to a communication system utilizing fingerprint information and use thereof.

### DESCRIPTION OF THE RELATED ART

Currently, people can send voice messages, videos, pictures and characters and the like via network by means of various chat software's, such as micro message, QQ, etc., and chat in group is provided in these software's. Also, these chat software's are popular and used by most of people, with the development of smart mobile phones and computers. However, any one who knows an account and corresponding password can obtain chat content, because no encrypting protection is provided for the chat content in such software.

### SUMMARY OF THE INVENTION

An object of the invention is to provide a communication system utilizing fingerprint information, by means of such a system, a transmitted message can be encrypted and decrypted on the basis of original communication application unit.

The following technical solution is employed in this invention:

a communication system utilizing fingerprint information comprising a fingerprint sensor and a communication application unit, the communication application unit including a communication software, a encrypting software and a decrypting software reverse to the encrypting software;

wherein the communication comprising the steps of:
a step (A) of adding friends:
extracting fingerprint information of a first user by means of a fingerprint sensor, and transmitting the fingerprint information of the first user and a instruction of adding friends through the communication software to a second user, extracting fingerprint information of the second user by means of a fingerprint sensor, and transmitting the fingerprint information of the second user and a instruction of confirming friends to the first user through the communication software after receiving the instruction of adding friends from the first user by the second user, and then the first user and second user becoming friends;
a step (B) of encrypting and sending a message:
extracting fingerprint information of the first user by means of a fingerprint sensor and inputting a message to be sent via a communication software by the first user, confirming the identity of the first user by means of the fingerprint information of the first user and sending the message to the second user through the communication software after being encrypted by the encrypting software;
a step (C) of decrypting and recognizing a message
extracting fingerprint information of the second user after receiving the encrypted message from the first user via the communication software, confirming the identity of the second user by means of the fingerprint information of the second user, recognizing and reading the message after being decrypted by the decrypting software by the second user.

Preferably, the communication software is selected from the group consisting of micro message, micro blog, QQ, MSN, SKYPE or any combination thereof.

Preferably, the message sent by the first user can be selected from the group of voice, character, picture, video or any combination thereof. More preferably, the communication system also comprises a step (D) before the step (A), the first or second user being able to register or login a communication software via fingerprint information thereof, and the user information of the first and second user being stored in the communication software.

Another object of the invention is to provide use of the communication system utilizing fingerprint information for use in a mobile phone.

Still another object of the invention is to provide use of the communication system utilizing fingerprint information for use in a computer.

By means of the above communication system, the present invention has the following advantages: encryption and decryption management can be performed by utilizing fingerprint information, thereby any one who don't have matching fingerprint can not read the encrypted message(s), thus, the privacy and safety of user information can be improved greatly on the basis of original system.

### BRIEF DESCRIPTION OF THE DRAWINGS

FIG. 1 is a flow chart of communication system according to the invention.

### DETAILED DESCRIPTION OF THE INVENTION

Preferred embodiments of the present invention will now be described in more detail hereinafter with reference to the drawings, so that the advantages and features of the invention can be easily understood by a person skilled in the art, thereby the protection scope of the invention is can be defined more clearly.

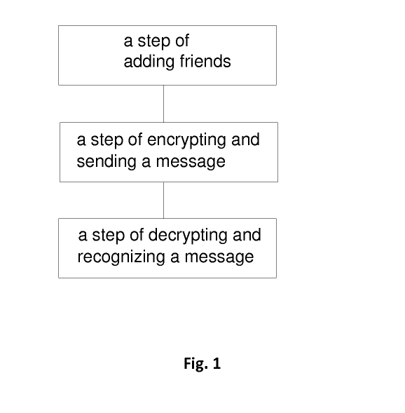

As shown in FIG. 1, a communication system utilizing fingerprint information comprising a fingerprint sensor and a communication unit is illustrated, wherein the communication unit includes a communication software, an encrypting software and a decrypting software reverse to the encrypting software.

The fingerprint sensor includes a memory and a fingerprint sensor, the fingerprint sensor is used for extracting fingerprint information and authenticating the fingerprint information. The memory is used for storing the fingerprint information and keys for encrypting and decrypting a message.

The communication comprises the steps of:

a step (A) of adding friends:
extracting fingerprint information of a first user by means of a fingerprint sensor, and transmitting the fingerprint information of the first user and a instruction of adding friends through the communication software to a second user, simultaneously, the fingerprint information of the first user being stored in the memory of the fingerprint sensor; extracting fingerprint information of the second user by means of a fingerprint sensor, and transmitting the fingerprint information of the second user and a instruction of confirming friends to the first user through the communication software after receiving the instruction of adding friends from the first user by the second user, simultaneously, the fingerprint information of the second user being stored in the memory of the fingerprint sensor; and
and the first user and second user becoming friends by exchanging fingerprint information;
a step (B) of encrypting and sending a message:
extracting fingerprint information of the first user by means of a fingerprint sensor and comparing the extracted fingerprint information to the fingerprint information stored in the memory of the fingerprint sensor to confirm the identity of the first user, after the first and second users becoming friends, if consistent, the identity of the first user is confirmed, and inputting a message to be sent via a communication software by the first user, and sending the message to the second user through the communication software after being encrypted by the encrypting software;
a step (C) of decrypting and recognizing a message
extracting fingerprint information of the second user after receiving the encrypted message from the first user and comparing the fingerprint information to the fingerprint information stored in the memory of the fingerprint sensor, if consistent, the identity of the second user is confirmed, recognizing the message after being decrypted by the decrypting software by the second user.

The communication application unit comprises a communication software, encrypting software and decrypting software.

Wherein, the communication software can be selected from the group of micro message, micro blog, QQ, MSN, SKYPE or any combination thereof. And the message sent by the first user can be selected from the group of voice, character, picture, video or any combination thereof. The encrypting and decrypting software can encrypt and decrypt a message reversely, which can be loaded into the communication software, and also can be program software which calls to each other with the communication software. The encrypting software can encrypt a message to be sent with fingerprint information, and the decrypting software can decrypt the encrypted message.

Such communication system disclosed in the invention can be used for mobile telephone, computer or various terminal units.

The difference of the second embodiment as compared with the first embodiment is in that, the communication system also includes a step (D) before the step (A), the first and second users can login the communication software through fingerprint information thereof, and thus the corresponding user information is stored in the communication software. The first and second users can register the communication software by utilizing fingerprint information thereof before entry into the communication software, and can login the communication software by means of fingerprint information after registering. As described previously, fingerprint information is unique for everyone, and thus the high-privacy is provided according to the present invention.

According to the communication method of the present invention, encryption and decryption management can be performed by utilizing fingerprint information, so that any one who don't have matching fingerprint information can not read the encrypted messages, accordingly, the privacy and safety of user information is improved greatly based on the original configuration.

Preferred embodiments are illustrated with reference to the accompanying drawings herein, however, it is obvious for a person skilled in the art that various modifications or variations can be made to the invention without departing from the spirit and protecting scope of the present invention, and such variations or variations would be covered within the protection scope of the invention.

What is claimed is:

1. A communication system utilizing fingerprint information comprising a fingerprint sensor and a communication application unit, the communication application unit including a communication software, a encrypting software and a decrypting software reverse to the encrypting software;
wherein the communication system comprising the steps of:
a step (A) of adding friends:
extracting fingerprint information of a first user by means of a fingerprint sensor, and transmitting the fingerprint information of the first user and a instruction of adding friends through the communication software to a second user, extracting fingerprint information of the second user by means of a fingerprint sensor, and transmitting the fingerprint information of the second user and a instruction of confirming friends to the first user through the communication software after receiving the instruction of adding friends from the first user by the second user, and then the first user and second user becoming friends;
a step (B) of encrypting and sending a message:
extracting fingerprint information of the first user by means of a fingerprint sensor and inputting a message to be sent via a communication software by the first user, confirming the identity of the first user by means of the fingerprint information of the first user and sending the message to the second user through the communication software after being encrypted by the encrypting software;
a step (C) of decrypting and recognizing a message
extracting fingerprint information of the second user after receiving the encrypted message from the first user via the communication software, confirming the identity of the second user by means of the fingerprint information of the second user, recognizing and reading the message after being decrypted by the decrypting software by the second user.

2. The communication system utilizing fingerprint information as claimed in claim 1, wherein the communication software is selected from the group of micro message, micro blog, QQ, MSN, SKYPE or any combination thereof.

3. The communication system utilizing fingerprint information as claimed in claim 1, wherein the message sent by the first user can be selected from the group of voice, character, picture, video or any combination thereof.

4. The communication system utilizing fingerprint information as claimed in claim 1, wherein the communication system also comprises a step (D) before the step (A), the first or second user being able to register or login a communication software via fingerprint information thereof, and the user information of the first and second user being stored in the communication software.

5. A method for applying the communication system utilizing fingerprint information of one of claims 1 to 4 in a mobile phone.

6. A method for applying the communication system utilizing fingerprint information of one of claims 1 to 4 in a computer.
